(19) United States
(12) Patent Application Publication
(10) Pub. No.: US 2024/0388488 A1
(43) Pub. Date: Nov. 21, 2024

(54) CUSTOMIZED CFR NOISE SHAPING OVER SPECTRUM

(71) Applicant: Meta Platforms, Inc., Menlo Park, CA (US)

(72) Inventors: Djordje Tujkovic, Los Altos, CA (US); Mohammad Janani, San Jose, CA (US)

(73) Assignee: Meta Platforms, Inc., Menlo Park, CA (US)

(21) Appl. No.: 18/174,727

(22) Filed: Feb. 27, 2023

Related U.S. Application Data
(60) Provisional application No. 63/380,705, filed on Oct. 24, 2022.

(51) Int. Cl. H04L 27/26; H04L 27/34

(52) U.S. Cl. CPC H04L 27/2623; H04L 27/3411

(57) ABSTRACT

Technology for customized crest factor reduction (CFR) noise shaping includes dividing a frequency band into a plurality of regions, assigning a constellation goal for each region, the respective constellation goal for at least two regions being different, determining a CFR noise level for each region based on the constellation goal for the region and a target CFR noise level for the divided frequency band, creating a cancellation pulse based on scaling factors, and based on the cancellation pulse, applying a cancellation pulse signal on a per-region basis to generate transmission signals having the determined CFR noise level for each region. In examples, a first region has a first constellation goal and a second region has a second constellation goal, and a determined CFR noise level for the first region supports the first constellation goal and a determined CFR noise level for the second region supports the second constellation goal.

### CROSS-REFERENCE TO RELATED APPLICATION(S)

This application claims the benefit of priority to U.S. Provisional Patent Application Ser. No. 63/380,705 entitled “Customized CFR Noise Shaping Over Spectrum,” filed on Oct. 24, 2022, which is incorporated herein by reference in its entirety.

### TECHNICAL FIELD

Examples generally relate to electronic communications technology. More particularly, examples relate to customized CFR noise shaping over an applicable spectrum to improve throughput.

### BACKGROUND

Crest factor reduction (CFR) is used in radio stations to reduce the high peak to average ratio (PAPR) of the base station signals on transmission (TX) chain. Power efficiency—a key feature of advanced radio designs—is tied to the PAPR of the signal. Information bits modulate a carrier electromagnetic wave signal to a set of desired phase, frequency and amplitude states. A set of allowed states is called a constellation. To support higher constellation signaling, radio systems can raise CFR clipping level, with less CFR noise but higher PAPR. Higher PAPR leads to the loss of power efficiency due to the need to back off more on input power to the transmission power amplifier (PA). In other words, to support higher constellation/rates in existing systems, it is required to lower the error vector magnitude (EVM), which is a measure of a difference between a reference waveform and a transmitted waveform. Lower EVM normally requires that the clipping level of CFR unit is raised to higher levels-hence, it would increase PAPR and thus lower power efficiency. Attempts to support higher constellation transmissions without losing power efficiency present difficult challenges.

### SUMMARY OF PARTICULAR EXAMPLES

In some examples, a method includes dividing a frequency band into a plurality of spectral regions, assigning a constellation goal for each spectral region, wherein the respective constellation goal for at least two spectral regions is different, determining a crest factor reduction (CFR) noise level for each spectral region based on the constellation goal for each spectral region and a target CFR noise level for the divided frequency band, creating a cancellation pulse based on scaling factors, and based on the cancellation pulse, applying a cancellation pulse signal on a per-spectral region basis to generate transmission signals having the determined CFR noise level for each spectral region.

In some examples, a computing system includes a processor, and a memory coupled to the processor, the memory comprising instructions which, when executed by the processor, cause the computing system to perform operations comprising dividing a frequency band into a plurality of spectral regions, assigning a constellation goal for each spectral region, wherein the respective constellation goal for at least two spectral regions is different, determining a crest factor reduction (CFR) noise level for each spectral region based on the constellation goal for each spectral region and a target CFR noise level for the divided frequency band, creating a cancellation pulse based on scaling factors, and based on the cancellation pulse, applying a cancellation pulse signal on a per-spectral region basis to generate transmission signals having the determined CFR noise level for each spectral region.

In some examples, at least one computer readable storage medium includes a set of instructions which, when executed by a computing device, cause the computing device to perform operations comprising dividing a frequency band into a plurality of spectral regions, assigning a constellation goal for each spectral region, wherein the respective constellation goal for at least two spectral regions is different, determining a crest factor reduction (CFR) noise level for each spectral region based on the constellation goal for each spectral region and a target CFR noise level for the divided frequency band, creating a cancellation pulse based on scaling factors, and based on the cancellation pulse, applying a cancellation pulse signal on a per-spectral region basis to generate transmission signals having the determined CFR noise level for each spectral region.

### BRIEF DESCRIPTION OF THE DRAWINGS

The various advantages of the examples will become apparent to one skilled in the art by reading the following specification and appended claims, and by referencing the following drawings, in which:

FIG. 1 provides a diagram illustrating a conventional signal spectrum;

FIGS. 2A-2B provide diagrams illustrating signal spectra with customized CFR noise shaping according to one or more examples;

FIGS. 3A-3D illustrate signal spectra plots for LTE signals with customized CFR noise shaping according to one or more examples;

FIG. 4 provides a diagram illustrating a masked cancellation pulse spectrum for customized CFR noise shaping according to one or more examples;

FIG. 5 provides a flow diagram illustrating a process of designing and implementing a masked cancellation pulse for customized CFR noise shaping according to one or more examples;

FIG. 6 provides a diagram illustrating a system for performing customized CFR noise shaping in accordance with one or more examples;

FIG. 7 provides a flow diagram illustrating a method of performing customized CFR noise shaping according to one or more examples; and

FIG. 8 provides a block diagram illustrating an architecture for a computing system for use in a performance-enhanced communications system according to one or more examples.

### DETAILED DESCRIPTION

Disclosed herein is improved communications system technology to shape the noise that is created by CFR, to provide support for higher constellations. This is done without changing PAPR, hence there is no change in power efficiency of the power amplifier used for transmission. The technology includes dividing (e.g., splitting) the spectrum (e.g., an applicable spectrum or frequency band) into several spectral regions and assigning a constellation goal for each spectral region. Then the CFR noise is managed to achieve the constellation goal for each spectral region. If one region is assigned with a higher constellation, then less CFR noise is pushed in that region (such region will have relatively lower than average EVM), and if another region has lower constellation, more CFR noise is allowed in that region (such region will have relatively higher than average EVM). This capability will allow communications equipment to support 1024-QAM and higher constellations in some regions without losing power efficiency. This idea can be applied, for example, to CFR in signals of Tier 1 and other lower Tier operators, as well as to cellular transmissions or WiFi transmissions more generally.

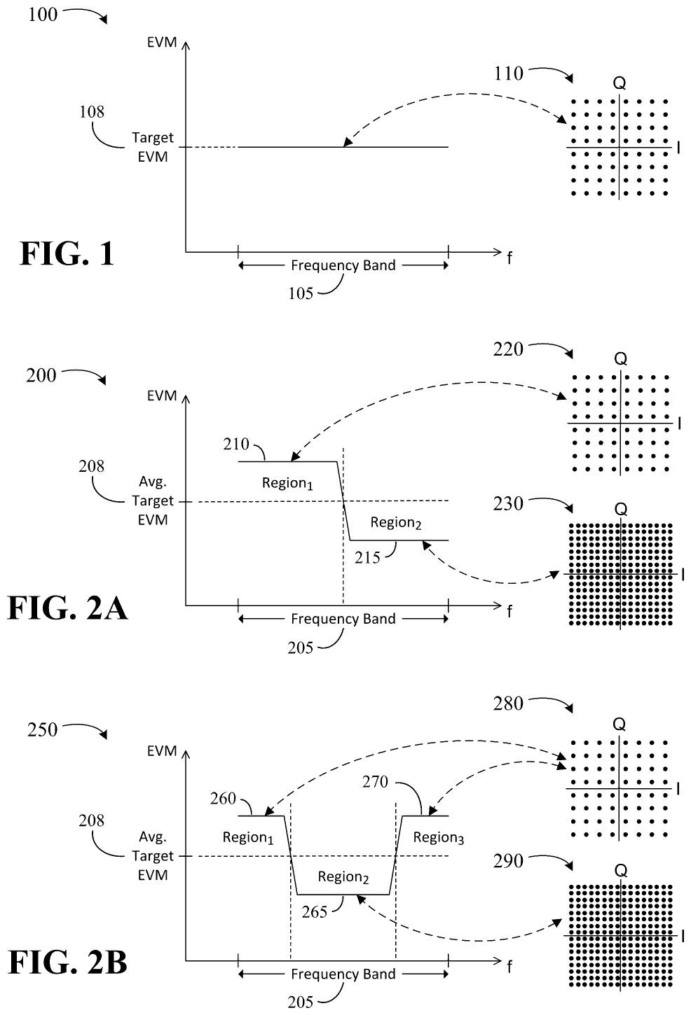

FIG. 1 provides a diagram illustrating a conventional signal spectrum 100. The conventional signal spectrum 100 spans a frequency band 105 which represents a frequency band of interest such as frequencies used by a base station for transmitting 5G or LTE/4G (e.g., cellular) signals to mobile devices. A target EVM 108 is selected for signals to be transmitted in the frequency band 105 corresponding to an average/customary CFR noise level. Thus, in conventional systems the CFR noise is evenly distributed over the applicable frequency spectrum to accommodate signal transmissions having up to a given constellation (e.g., conventional or customary signal constellation). The target EVM 108 and/or the average CFR noise level can also correspond to a desired PAPR for the signals transmitted by the base station. The target EVM 108 (and/or the average CFR noise level) enables or supports signal transmissions with a constellation value illustrated by the constellation diagram 110. For example, if the target EVM 108 is 2.5% (e.g., a customary EVM for LTE signals), this EVM would support signal transmissions with a constellation value of 256 QAM (quadrature amplitude modulation) for the frequency band 105. Thus all resource blocks (in the frequency band 105 would have the same target EVM. A resource block (RB) is a group of frequencies (e.g., 12 tones) assigned to a cellular user—e.g., a RB represents the smallest group of frequencies that can be allocated to a cellular user.

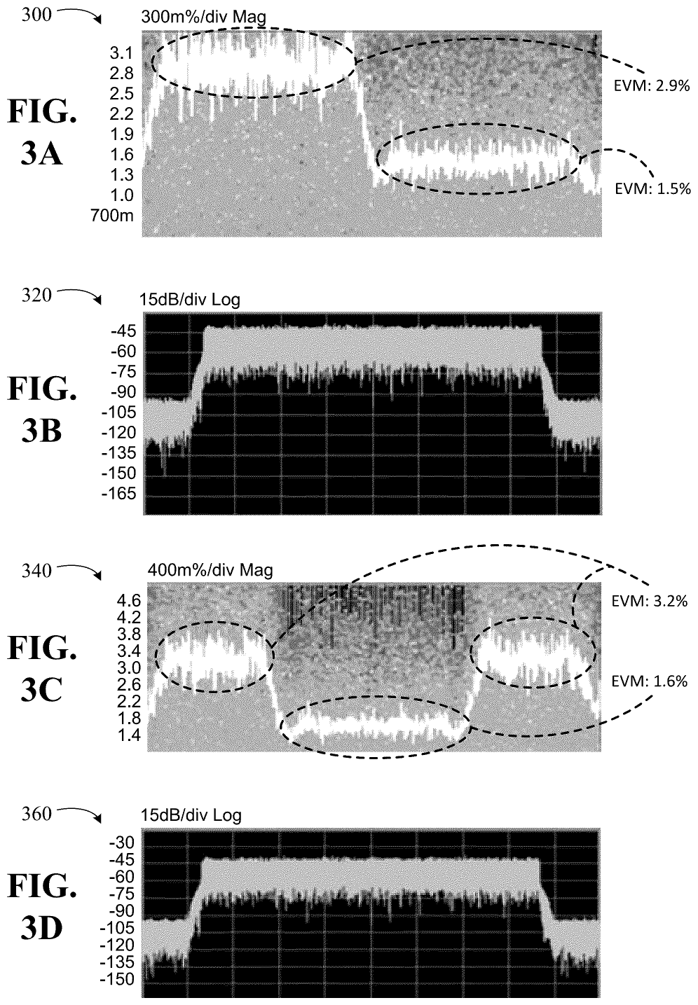

FIGS. 2A-2B provide diagrams illustrating signal spectra 200 and 250 with customized CFR noise shaping according to one or more examples, with reference to components and features described herein including but not limited to the figures and associated description. The examples in FIGS. 2A and 2B both represent two-level target EVM. Turning to FIG. 2A, a spectrum 200 is shown including a frequency band 205, which represents a frequency band of interest. For example, the frequency band 205 can represent a band of frequencies used by a base station for transmitting 5G or LTE/4G (e.g., cellular) signals to mobile devices (e.g., user devices). An another example, the frequency band 205 can represent a band of frequencies used by wireless access point for transmitting WiFi signals to (e.g., user devices).

An average target EVM 208 corresponding to a desired average CFR noise level is selected for signals to be transmitted in the frequency band 205. In examples the average target EVM 208 and/or the desired average CFR noise level is selected based on the average/customary CFR noise level (and/or the PAPR) for signals transmitted in the frequency band 105 (FIG. 1, already discussed). In examples the average target EVM 208 and/or the desired CFR noise level is selected based on the average CFR noise level (and/or the PAPR) for signals transmitted by one or more existing base station(s) in a similar operating environment. Unlike the target EVM 108 (FIG. 1, already discussed) which is fixed/flat for the entire frequency band 105, the target EVM illustrated in FIG. 2A is region-dependent. That is, the frequency band 205 is divided into regions, where each region has a specific per-region target EVM. In examples, the average target EVM 208 represents a weighted average of the target EVM for each of the two regions (e.g., weighted by the proportion of the respective regions to the frequency band 205).

As shown in FIG. 2A, an example spectrum 200 has the frequency band 205 divided into two equal-sized regions. The first region (Region₁) has a first per-region target EVM 210, and the second region (Region₂) has a second per-region target EVM 215. The first per-region target EVM 210 supports signal transmissions with a constellation value illustrated by the constellation diagram 220. As an example, if the first per-region target EVM 210 is 2.9%, this EVM would support signal transmissions with a constellation value of 256 QAM for Region₁ of the frequency band 205. Similarly, as another example if the first per-region target EVM 210 is lower than 3.5%, this EVM would also support signal transmissions with a constellation value of 256 QAM for Region₂ of the frequency band 205.

The second per-region target EVM 215 supports signal transmissions with a constellation value illustrated by the constellation diagram 230. As an example, if the second per-region target EVM 215 is 1.5%, this EVM would support signal transmissions with a constellation value of 1024 QAM for Region₂ of the frequency band 205. Similarly, as another example if the second per-region target EVM 215 is lower than 1.7%, this EVM would also support signal transmissions with a constellation value of 1024 QAM for Region₂ of the frequency band 205. In an example where the first per-region target EVM 210 is 2.9% and the second per-region target EVM 215 is 1.5%, the average target EVM 208 would be approximately 2.2%. More generally, as illustrated in FIG. 2A the second per-region target EVM 215 is lower than the first per-region target EVM 210 and, thus, signal transmissions in Region₂ will be of higher constellation value (e.g., constellation diagram 230) than the constellation value (e.g., constellation diagram 220) for signal transmissions in Region₁.

Turning now to FIG. 2B, an example spectrum 200 has the frequency band 205 divided into three regions. The first region (Region₁) has a first per-region target EVM 260, the second region (Region₂) has a second per-region target EVM 265, and the third region (Region₃) has a third per-region target EVM 270. The second region (Region₂) is twice as wide as each of the first region (Region₁) and the third region (Region₃)—thus in the illustrated example half of the frequency band (e.g., half of the RBs) has a lower target EVM and half (e.g., half of the RBs) has higher target EVM. In examples, the average target EVM 208 represents a weighted average of the target EVM for each of the three regions (e.g., weighted by the proportion of the respective regions to the frequency band 205).

The first per-region target EVM 260 and the third per-region target EVM 270 both support signal transmissions with a constellation value illustrated by the constellation diagram 280. As an example, if the first per-region target EVM 260 is 3.2%, this EVM would support signal transmissions with a constellation value of 256 QAM for Region of the frequency band 205. Similarly, if the third per-region target EVM 270 is 3.2%, this EVM would support signal transmissions with a constellation value of 256 QAM for Region₃ of the frequency band 205.

The second per-region target EVM 265 supports signal transmissions with a constellation value illustrated by the constellation diagram 290. As an example, if the second per-region target EVM 265 is 1.6%, this EVM would support signal transmissions with a constellation value of 1024 QAM for Region₂ of the frequency band 205. In an example where the first per-region target EVM 260 is 3.2%, the second per-region target EVM 265 is 1.6%, and the third per-region target EVM 270 is 3.2%, the average target EVM 208 would be approximately 2.4%-2.5%. More generally, as illustrated in FIG. 2B the second per-region target EVM 265 is lower than the first per-region target EVM 260 and the third per-region target EVM 270 and, thus, signal transmissions in Region₂ will be of higher constellation value (e.g., constellation diagram 290) than the constellation value (e.g., constellation diagram 280) for signal transmissions in Region₁ and/or Region₃.

Thus, the per-region target EVM technology as described herein enables a transmission system (e.g., base station or WAP) to provide enhanced/higher signal constellations (e.g., 1024 QAM) for a portion of the spectrum users (RBs) while maintaining conventional or customary signal constellations (e.g., 256 QAM) for other portion(s) of the spectrum users (RBs), while maintaining power efficiency—e.g., the same or lower PAPR for the transmissions. That is, there is no need to raise clipping levels to support lower EVM for a portion of the RBs in a frequency band. In some examples, a base station can assign better downlink rates based on signal-to-noise (SNR) feedback or EVM feedback. In some examples, a base station knows which parts (e.g., region(s) of the spectrum has lower CFR noise (better EVM) and can map higher-rate users to those region(s).

In some examples, there is a transition area between regions where certain transient tones have a target EVM that is different than the per-region target EVM for the specified regions. For example, as illustrated in FIG. 2A there is a narrow transition area between Region₁ and Region₂ where the target EVM for tones in the transition area have a target EVM that lies between the target EVM 210 (for Region₁) and the target EVM 215 (for Region₂). Similarly, as another example, as illustrated in FIG. 2B there is a first narrow transition area between Region and Region₂ where the target EVM for tones in the first transition area have a target EVM that lies between the target EVM 260 (for Region₁) and the target EVM 265 (for Region₂), and a second narrow transition area between Region₂ and Region₃ where the target EVM for tones in the second transition area have a target EVM that lies between the target EVM 265 (for Region₂) and the target EVM 270 (for Region₃). In some examples the transition area between regions is broader or narrower than illustrated in FIGS. 2A-2B. In some examples there is no transition area between regions. In some examples a transition area is assigned target EVM between regions based on the amount of difference (e.g. a threshold amount) in target EVM between neighboring regions. It will be understood that, in examples, each tone in a region can have its own EVM that is approximately the same as the target EVM for that region (e.g., within a threshold amount of the target EVM).

In some examples, the frequency band 205 has a width of 20 MHz. In some examples, the frequency band 205 has a width that is a multiple of 20 MHz (e.g., 2×20 MHz, 4×20 MHz, etc.). In some examples, the frequency band 205 has a width that is broader or narrower than 20 MHz (or a multiple thereof). In some examples, the frequency band 205 (e.g., the applicable spectrum) is divided into two regions, as illustrated in FIG. 2A. In some examples, the frequency band 205 (e.g., the applicable spectrum) is divided into three regions, as illustrated in FIG. 2B. In some examples, the frequency band 205 (e.g., the applicable spectrum) is divided into more than three regions (e.g., four regions, five regions, etc.). In some examples, the regions are of the same or similar width. In some examples, some or all of the regions are of differing widths. For example, in cellular communications each resource block (RB) or each frequency tone can be a region having a target EVM. In some examples, each region includes several RBs.

FIGS. 3A-3D illustrate signal spectra plots for LTE signals with customized CFR noise shaping according to one or more examples, with reference to components and features described herein including but not limited to the figures and associated description. Turning to FIG. 3A, a spectral plot 300 shows two-level EVM over a 20 Mhz frequency band. The frequency band has been divided into two regions. One region has an EVM of 2.9%, which supports signal transmissions with a constellation value of 256 QAM. The other region has an EVM of 1.5%, which supports signal transmissions with a constellation value of 1024 QAM. The average EVM for the overall frequency band is approximately 2.2%. The spectral plot in FIG. 3A represents an example of a signal spectrum with customized CFR noise shaping as illustrated in FIG. 2A. In RF systems, for each region there is some variations of the EVM, However, the average EVM for each region sets the target supporting constellations as long as the peak of the variations do not exceed a threshold.

FIG. 3B shows a power spectral plot 320 corresponding to the signals represented in the EVM plot of FIG. 3A. As shown in the power spectral plot 320, having different EVM levels (as shown in FIG. 3A) does not affect the power spectrum of the signal. That is, even though there are two regions of different EVM (FIG. 3A), the power spectrum of the signal (FIG. 3B) is the same over all these regions.

Turning now to FIG. 3C, a spectral plot 340 shows two-level EVM over a 20 Mhz frequency band. The frequency band has been divided into three regions. Two smaller regions have an EVM of 3.2%, which supports signal transmissions with a constellation value of 256 QAM. A third, larger region has an EVM of 1.6%, which supports signal transmissions with a constellation value of 1024 QAM. The average EVM for the overall frequency band is approximately 2.5%. The spectral plot in FIG. 3C represents an example of a signal spectrum with customized CFR noise shaping as illustrated in FIG. 2B.

FIG. 3D shows a power spectral plot 360 corresponding to the signals represented in the EVM plot of FIG. 3C. As shown in the power spectral plot 360, having different EVM levels (as shown in FIG. 3C) does not affect the power spectrum of the signal. That is, even though there are three regions of different EVM (FIG. 3C), the power spectrum of the signal (FIG. 3D) is the same over all these regions.

In examples, per-region target EVM is accomplished by using a cancellation pulse design for intra band multilevel CFR noise within the carrier signal. Cancellation pulses are used to cancel peak values and thus reduce PAPR for a given signal. Conventional cancellation pulse design uses a cancellation pulse signal having a relatively flat peak spectral region within the bandwidth of the pulse signal. In accordance with examples of the disclosed technology herein, cancellation pulse design includes using a masked cancellation pulse signal having a peak spectral region that varies across the pulse bandwidth, with different levels corresponding to per-region EVM levels in which the frequency band has been divided.

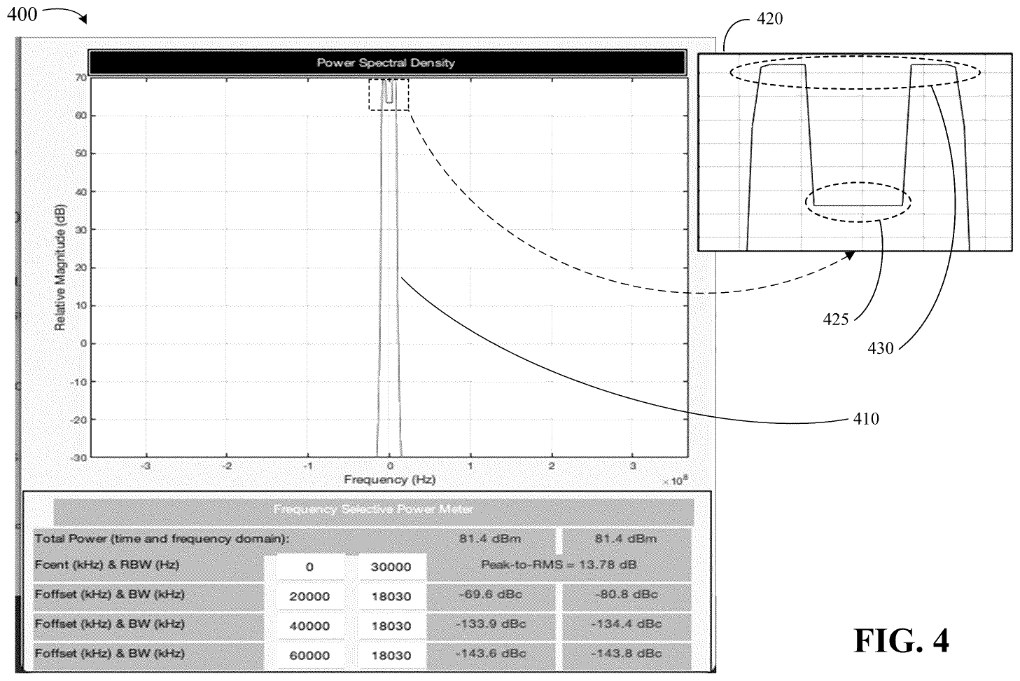

Turning to FIG. 4, shown is a diagram illustrating a masked cancellation pulse spectrum 400 for customized CFR noise shaping according to one or more examples, with reference to components and features described herein including but not limited to the figures and associated description. The cancellation pulse spectrum 400 corresponds to a cancellation pulse signal used to obtain the signals illustrated in FIG. 3C (and is also representative of generating signals having two-level EVM as illustrated in FIG. 2B). As shown in FIG. 4, the spectrum 400 includes a peak region 410 centered at zero (0) Hz with a bandwidth of approximately 18 MHz. (for the example shown in FIGS. 3C and 3D). Rather than a relatively flat peak spectral region, the peak region 410 has two sub-regions with levels that differ across the pulse bandwidth.

An expanded illustration 420 for the peak region 410 shows the mask spectrum with peak sub-regions with two levels: a sub-region 425 with relatively lower cancellation pulse spectrum level, and a sub-region 430 with relatively higher cancellation pulse spectrum level. These regions show that the CFR noise is not uniformly distributed, but varies per region. The two sub-regions means that the cancellation pulse signal will support two levels of CFR noise and, hence, two levels of EVM. For example, the sub-region 425 can correspond to Region₂ (FIG. 2B), while the sub-region 430 can correspond to Region and Region₃ (FIG. 2B). With a relatively lower cancellation pulse spectrum level, the sub-region 425 has lower CFR noise and, thus, the EVM equivalent of that region is also much lower (e.g., better EVM) compared with the rest of the spectrum (sub-region 430).

Thus, by shaping the cancellation pulse signal to provide a spectrum having different levels in different sub-regions (in some examples, similar to the spectrum 400 and in particular the peak spectrum 410 in FIG. 4), the cancellation pulse signal can provide multiple EVM levels for signal transmissions. By shaping the cancellation pulse signal, the CFR distortion is rearranged to have RBs with assigned EVM levels. For example, the cancellation pulse signal can be used to provide some RBs with lower CFR noise (lower EVM) to support given higher constellation targets and other RBs with higher CFR noise/higher EVM supporting conventional or customary constellation targets—while efficiency and PAPR are unchanged.

In examples, one of several techniques is employed to produce a shaped cancellation pulse signal, starting with a generic (unmasked) cancellation pulse signal to provide the desired multi-level EVM. One technique involves frequency domain shaping via a mask: (a) perform a Fourier transform such as a fast Fourier transform (FFT) on the generic cancellation pulse to obtain a frequency domain representation of the pulse; (b) multiply the frequency domain representation of the pulse with the desired frequency shaping mask; and (c) perform an inverse Fourier transform such as inverse-FFT on the results. In some examples, the desired frequency shaping mask has a shape/characteristic similar to the spectrum 400 (FIG. 4, already discussed).

A second technique involves cancellation pulse aggregation. In this technique, a generic cancellation pulse of lower bandwidth is upconverted and aggregated in a way that the aggregated pulses have the desired overall cancellation pulse shape. Each of these cancellation pulses can be multiplied by a scaler to implement the aggregate/overall (masked) cancellation pulse.

Another technique involves filtering, using a filter designed to have a frequency spectrum (e.g., mask shape) corresponding to the desired frequency shaping mask. In some examples, the desired frequency shaping mask has a shape/characteristic similar to the spectrum 400 (FIG. 4, already discussed). The filter can be designed based on regular filter designs such finite impulse response (FIR), infinite impulse response (IIR) etc. Once the filter is designed, the generic cancellation pulse is run through this filter to provide the output (masked) cancellation pulse. In some examples the center tone of the signal is normalized to equal one.

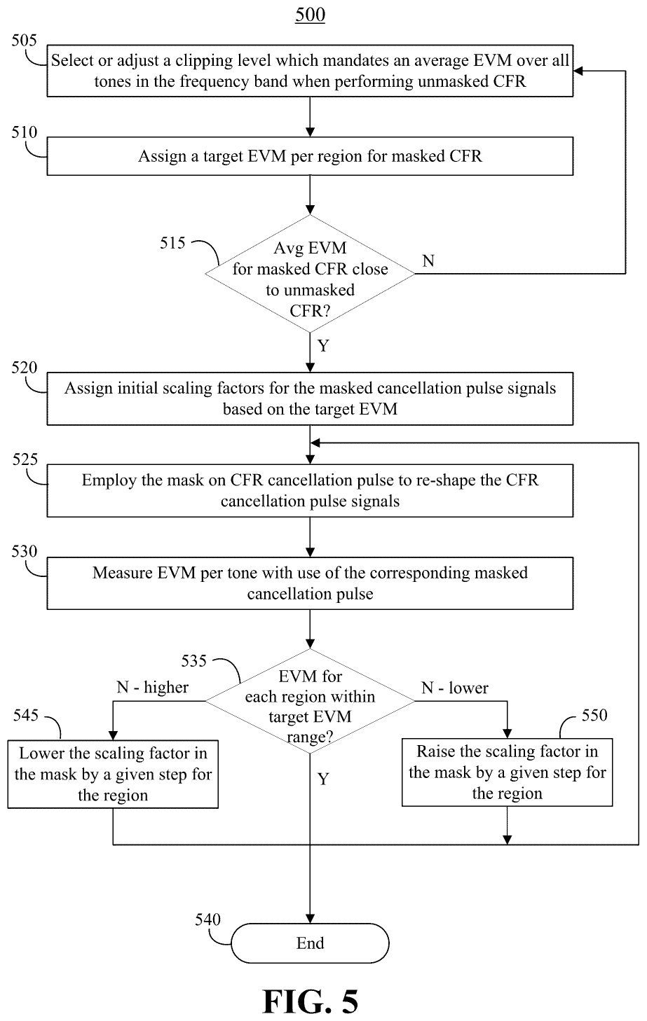

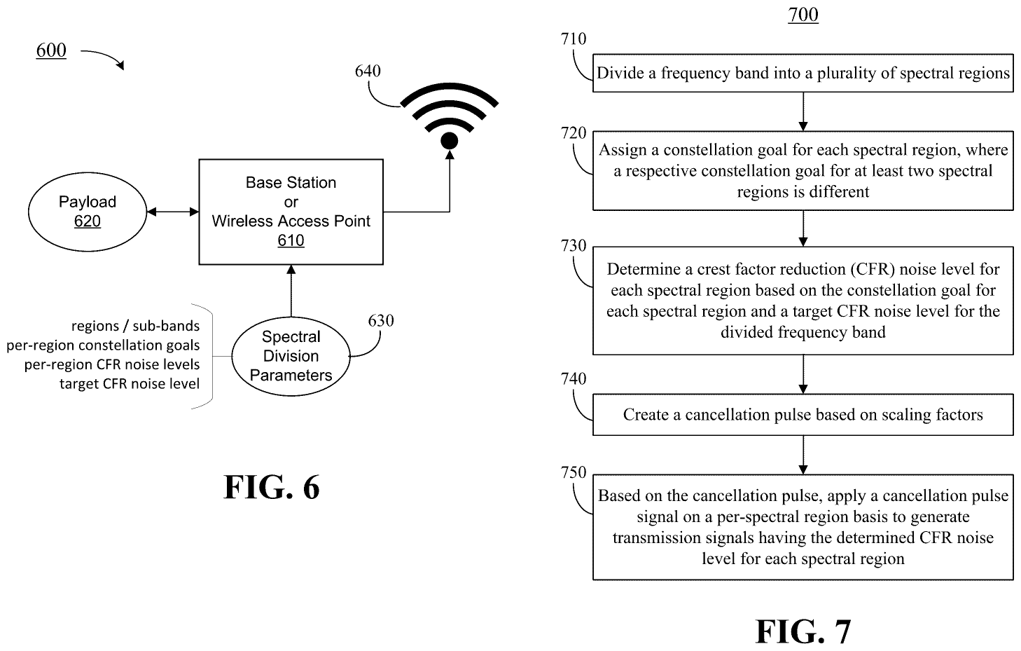

FIG. 5 provides a flow diagram illustrating a process 500 of designing and implementing a masked cancellation pulse for customized CFR noise shaping according to one or more examples, with reference to components and features described herein including but not limited to the figures and associated description. The process 500 can generally be implemented in (or in connection with) a wireless transmission system such as, e.g., the system 600 (FIG. 6), a base station and/or a WAP. For example, the process 500 can be operated once for a given set of EVM targets, and then the resulting cancellation pulse design can be used (and re-used) in many wireless transmission systems without the need for performing run-time adjustments. For example, the EVM targets and cancellation pulse design can be employed for multicarrier 5G signals. As another example, each carrier can employ a specific or dedicated multilevel per-region EVM with cancellation pulse.

More particularly, the process 500 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the process 500 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Block 505 provides for selecting a clipping level (e.g., an initial clipping level) which mandates an average EVM over all tones in the frequency band when performing unmasked CFR (e.g., performing CFR with an unmasked (normal) peak cancellation pulse).

Block 510 provides for assigning a target EVM per region (e.g., for frequency tones or resource blocks in each region) over the whole frequency band, such that the average EVM over all regions (e.g., all tones or resource blocks) is close to the overall average EVM of the unmasked CFR result (block 505). For example, there can be two regions (as illustrated in FIG. 2A), three regions (as illustrated in FIG. 2B), or more than three regions. Some region(s) will have target EVM lower than the average EVM to support signals with higher constellation goals, and some region(s) (e.g., the remaining regions) will have target EVM higher than the average EVM to support conventional or customary constellation goals. Where average EVM (all regions) for masked CFR is approximately the same as average EVM for unmasked CFR, this would satisfy the “close to” test. In some examples, there is a transition area between regions where certain transient tones have a target EVM that is different than the per-region target EVM for the specified regions (e.g., as described with reference to FIGS. 2A-2B herein).

In some examples assigning a target EVM per region includes applying a tolerance margin on the target EVM to create an EVM target that is a range per region (or range per tone or per resource block). In some examples a target EVM margin (range) is unequal for region(s) with lower than target EVM and region(s) with higher than target EVM. For example, if it is desired to have Region₂ (as shown in FIG. 2B) to support 1024QAM, then the average EVM should be below 1.7%, and a lower bound for the range can be selected for, e.g., 1.4% to avoid pushing all the noise to other regions.

Block 515 provides that if the average EVM for masked CFR is not close to overall EVM of unmasked CFR, then an adjustment to the clipping level (block 505) is needed to achieve the target average EVM.

Block 520 provides for assigning initial scaling factors for the masked cancellation pulse signal based on a target EVM range. In some examples the scaling factors can start with 1 for all and then go below one for the tones with EVM targets that are lower than other tones' EVM targets. For example, if lower EVM is needed for a tone then a lower scaling factor than 1 is needed proportional to the EVM of resource blocks. The scaling factors create region levels such as, e.g., for sub-regions 425 and 430 shown in FIG. 4. The lower the level, the lower the EVM would be (e.g., sub-region 425 is lower than sub-region 430).

Block 525 provides for employing the mask on CFR cancellation pulse to re-shape the CFR cancellation pulse. The mask is derived based on the scaling factors of block 520.

Block 530 provides for measuring EVM per tone with use of the corresponding masked cancellation pulse. Measuring EVM per tone can be accomplished, e.g., via vector signal analysis (VSA) of CFR results or via baseband computations. For example, an average EVM can be obtained for each tone or RB, or an average EVM can be obtained over all the tones or RBs of the region.

Block 535 provides for determining if the average EVM of each region falls within the target EVM range for that region. If yes, the process ends (block 540). If no, at block 545 the process continues by lowering the scaling factor in the mask by a given step for the region if the EVM for the given region is higher than the target EVM range, or at block 550 by raising the scaling factor in the mask by a given step for the region if the EVM for the given region is lower than the target EVM range. The scaling step size can be adjusted for each iteration to achieve the required EVM resolution. For example, the scaling adjustment step size can be determined based on total noise calculation, or by a heuristic method, etc. The scaling adjustment step size should be fine enough to not miss the target EVM range. For example, the scaling can be adjusted by dB steps or fractional dB steps until the EVM measurements pass the range threshold. After block 545 or block 550, the process repeats blocks 525-535 with the new adjusted mask until all regions have an average EVM falling within their target EVM range. In some examples, if the process does not succeed in establishing EVMs within the target EVM range, after a given number of iterations, the process returns to block 505 and raises the clipping level by a given step, then proceeds with block 510.

FIG. 6 provides a block diagram illustrating a system 600 for performing customized CFR noise shaping over an applicable spectrum according to one or more examples, with reference to components and features described herein including but not limited to the figures and associated description. As shown in FIG. 6, the system 600 includes a base station/wireless access point (WAP) 610 that receives a payload 620 for transmission, and applies spectral division with parameters 630 to generate transmission signals 640 to be transmitted to one or more user devices (e.g., a user equipment) or other devices in a wireless network. The base station/WAP 610 can include one or more a wireless transceiver(s). For example, the base station/WAP 610 can include a stationary transceiver that serves as a hub for wireless device connectivity within a particular area (e.g., a cell). As another example, the base station/WAP 610 can include a WiFi transmitter (e.g., router) that transmits WiFi signals to user devices. The base station/WAP 610 can include a processor or computing system to perform operations to carry out the customized CFR noise shaping techniques as described herein. The payload 620 includes communications (such as, e.g., cellular calls) or other information (such as, e.g., digital communications, html data, etc.) being sent by the base station/WAP 610 to user devices.

Spectral division parameters 630 can include region or sub-band definitions (e.g., one or more resource blocks (RBs) in each region) based on the applicable frequency band, per-region constellation goals, per-region CFR noise levels, and a target CFR noise level (e.g., for the applicable frequency band). Using the spectral division parameters 630, the base station/WAP 610 performs customized CFR noise shaping over an applicable spectrum, for example as described herein with reference to FIGS. 2A-2B, 3A-3B, and 4-5. As one example, the spectral division parameters 630 can be loaded into firmware in the base station/WAP 610. The cancellation pulse can be made or generated in a computer host or in a base station once the configuration and EVM of each region is set. The cancellation pulse normally does not change over run time (as the carrier configuration does not). Then the cancellation pulse can be saved in the base station or access point by firmware and be used by the CFR engine to make the signal clipping.

Some or all components in the system 600 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system 600 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAS, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system 600 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 7 provides a flow diagram illustrating a method 700 of performing customized CFR noise shaping over an applicable spectrum according to one or more examples, with reference to components and features described herein including but not limited to the figures and associated description. The method 700 can generally be implemented in the system 600 (FIG. 6, already discussed). More particularly, the method 700 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 700 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 710 provides for dividing a frequency band into a plurality of spectral regions. Illustrated processing block 720 provides for assigning a constellation goal for each spectral region, where a respective constellation goal for at least two spectral regions is different. Illustrated processing block 730 provides for determining a crest factor reduction (CFR) noise level for each spectral region based on the constellation goal for each spectral region and a target CFR noise level for the divided frequency band. Illustrated processing block 740 provides for creating a cancellation pulse based on scaling factors. Illustrated processing block 750 provides for applying, based on the cancellation pulse, a cancellation pulse signal on a per-spectral region basis to generate transmission signals having the determined CFR noise level for each spectral region.

In some examples, the target CFR noise level for the divided frequency band is approximately the same as an average CFR noise level for the frequency band in an undivided state. In some examples, a first spectral region has a first constellation goal and a second spectral region has a second constellation goal, and a first determined CFR noise level for the first spectral region supports the first constellation goal and a second determined CFR noise level for the second spectral region supports the second constellation goal. In some examples, the first constellation goal is 256-QAM, and wherein the second constellation goal is 1024-QAM.

In some examples, a third spectral region has a third constellation goal and a third determined CFR noise level for the third spectral region supports the third constellation goal. In some examples, the third constellation goal is equal to one of the first constellation goal or the second constellation goal. In some examples, the cancellation pulse is created using a frequency mask based on a fast Fourier transform (FFT) or a digital filter.

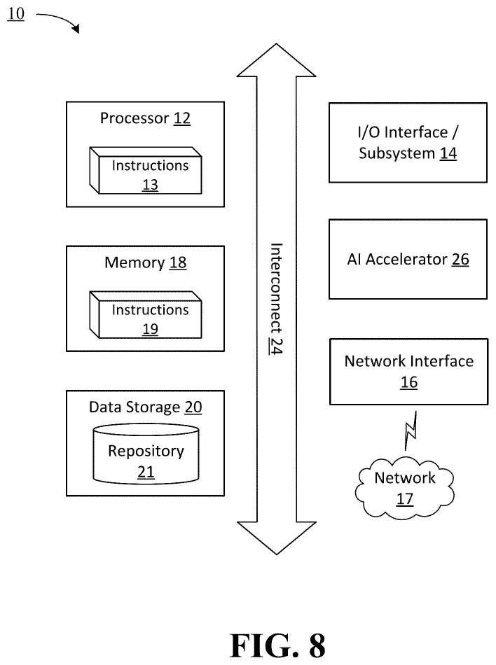

FIG. 8 is a block diagram illustrating an architecture for a computing system 10 for use in a performance-enhanced communications system according to one or more examples, with reference to components and features described herein including but not limited to the figures and associated description. In some examples, the computing system 10 can be used to implement any of the devices or components described herein, including the base station/WAP 610 (FIG. 6), and/or any other system components. In some examples, the computing system 10 can be used to implement any of the processes described herein including the process 500 (FIG. 5), and/or the method 700 (FIG. 7). The computing system 10 includes one or more processors 12, an input-output (I/O) interface/subsystem 14, a network interface 16, a memory 18, and a data storage 20. These components are coupled or connected via an interconnect 24. Although FIG. 9 illustrates certain components, the computing system 10 can include additional or multiple components coupled or connected in various ways. It is understood that not all examples will necessarily include every component shown in FIG. 8.

The processor 12 can include one or more processing devices such as a microprocessor, a central processing unit (CPU), a fixed application-specific integrated circuit (ASIC) processor, a reduced instruction set computing (RISC) processor, a complex instruction set computing (CISC) processor, a field-programmable gate array (FPGA), a digital signal processor (DSP), etc., along with associated circuitry, logic, and/or interfaces. The processor 12 can include, or be connected to, a memory (such as, e.g., the memory 18) storing executable instructions 19 and/or data, as necessary or appropriate. The processor 12 can execute such instructions to implement, control, operate or interface with any devices, components, features or methods described herein with reference to FIGS. 2A-2B, 3A-3B, 4, 5, 6, and 7. The processor 12 can communicate, send, or receive messages, requests, notifications, data, etc. to/from other devices. The processor 12 can be embodied as any type of processor capable of performing the functions described herein. For example, the processor 12 can be embodied as a single or multi-core processor(s), a digital signal processor, a microcontroller, or other processor or processing/controlling circuit. The processor can include embedded instructions 13 (e.g., processor code).

The I/O interface/subsystem 14 can include circuitry and/or components suitable to facilitate input/output operations with the processor 12, the memory 18, and other components of the computing system 10. The I/O interface/subsystem 14 can include a user interface including code to present, on a display, information or screens for a user and to receive input (including commands) from a user via an input device (e.g., keyboard or a touch-screen device).

The network interface 16 can include suitable logic, circuitry, and/or interfaces that transmits and receives data over one or more communication networks using one or more communication network protocols. The network interface 16 can operate under the control of the processor 12, and can transmit/receive various requests and messages to/from one or more other devices (such as, e.g., any one or more of the devices illustrated in FIGS. 2A-2B, 3A-3B, 4, 5, 6, and 7. The network interface 16 can include wired or wireless data communication capability; these capabilities can support data communication with a wired or wireless communication network, such as the network 17, and/or further including the Internet, a wide area network (WAN), a local area network (LAN), a wireless personal area network, a wide body area network, a cellular network, a telephone network, any other wired or wireless network for transmitting and receiving a data signal, or any combination thereof (including, e.g., a WiFi network or corporate LAN). The network interface 16 can support communication via a short-range wireless communication field, such as Bluetooth, NFC, or RFID. Examples of network interface 16 can include, but are not limited to, an antenna, a radio frequency transceiver, a wireless transceiver, a Bluetooth transceiver, an ethernet port, a universal serial bus (USB) port, or any other device configured to transmit and receive data.

The memory 18 can include suitable logic, circuitry, and/or interfaces to store executable instructions and/or data, as necessary or appropriate, when executed, to implement, control, operate or interface with any devices, components, features or methods described herein with reference to FIGS. 2A-2B, 3A-3B, 4, 5, 6, and 7. The memory 18 can be embodied as any type of volatile or non-volatile memory or data storage capable of performing the functions described herein, and can include a random-access memory (RAM), a read-only memory (ROM), write-once read-multiple memory (e.g., EEPROM), a removable storage drive, a hard disk drive (HDD), a flash memory, a solid-state memory, and the like, and including any combination thereof. In operation, the memory 18 can store various data and software used during operation of the computing system 10 such as operating systems, applications, programs, libraries, and drivers. The memory 18 can be communicatively coupled to the processor 12 directly or via the I/O subsystem 14. In use, the memory 18 can contain, among other things, a set of machine instructions 19 which, when executed by the processor 12, causes the processor 12 to perform operations to implement examples of the present disclosure.

The data storage 20 can include any type of device or devices configured for short-term or long-term storage of data such as, for example, memory devices and circuits, memory cards, hard disk drives, solid-state drives, non-volatile flash memory, or other data storage devices. The data storage 20 can include or be configured as a database, such as a relational or non-relational database, or a combination of more than one database. In some examples, a database or other data storage can be physically separate and/or remote from the computing system 10, and/or can be located in another computing device, a database server, on a cloud-based platform, or in any storage device that is in data communication with the computing system 10. In some examples, the data storage 20 includes a data repository 21, which in some examples can include data for a specific application.

The interconnect 24 can include any one or more separate physical buses, point to point connections, or both connected by appropriate bridges, adapters, or controllers. The interconnect 24 can include, for example, a system bus, a Peripheral Component Interconnect (PCI) bus, a HyperTransport or industry standard architecture bus, a small computer system interface (SCSI) bus, a universal serial bus (USB), IIC (I2C) bus, or an Institute of Electrical and Electronics Engineers (IEEE) standard 694 bus (e.g., “Firewire”), or any other interconnect suitable for coupling or connecting the components of the computing system 10.

In some examples, the computing system 10 also includes an accelerator, such as an artificial intelligence (AI) accelerator 24. The AI accelerator 24 includes suitable logic, circuitry, and/or interfaces to accelerate artificial intelligence applications, such as, e.g., artificial neural networks, machine vision and machine learning applications, including through parallel processing techniques. In one or more examples, the AI accelerator 24 can include hardware logic or devices such as, e.g., a graphics processing unit (GPU) or an FPGA. The AI accelerator 24 can implement one or more devices, components, features or methods described herein with reference to FIGS. 2A-2B, 3A-3B, 4, 5, 6, and 7.

In some examples, the computing system 10 also includes a display (not shown in FIG. 8). In some examples, the computing system 10 also interfaces with a separate display such as, e.g., a display installed in another connected device (not shown in FIG. 8). The display can be any type of device for presenting visual information, such as a computer monitor, a flat panel display, or a mobile device screen, and can include a liquid crystal display (LCD), a light-emitting diode (LED) display, a plasma panel, or a cathode ray tube display, etc. The display can include a display interface for communicating with the display. In some examples, the display can include a display interface for communicating with a display external to the computing system 10.

In some examples, one or more of the illustrative components of the computing system 10 can be incorporated (in whole or in part) within, or otherwise form a portion of, another component. For example, the memory 18, or portions thereof, can be incorporated within the processor 12. As another example, the I/O interface/subsystem 14 can be incorporated within the processor 12 and/or code (e.g., instructions 19) in the memory 18. In some examples, the computing system 10 can be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device.

In some examples, the computing system 10, or portion(s) thereof, is/are implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Examples of each of the above systems, devices, components, features and/or methods, including the process 500, the system 600, the method 700, and/or any other system components, can be implemented in hardware, software, or any suitable combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

Alternatively, or additionally, all or portions of the foregoing systems, devices, components, features and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### Additional Notes and Examples

Example M1 includes a method comprising dividing a frequency band into a plurality of spectral regions, assigning a constellation goal for each spectral region, wherein a respective constellation goal for at least two spectral regions is different, determining a crest factor reduction (CFR) noise level for each spectral region based on the constellation goal for each spectral region and a target CFR noise level for the divided frequency band, creating a cancellation pulse based on scaling factors, and based on the cancellation pulse, applying a cancellation pulse signal on a per-spectral region basis to generate transmission signals having the determined CFR noise level for each spectral region.

Example M2 includes the method of Example M1, wherein the target CFR noise level for the divided frequency band is approximately the same as an average CFR noise level for the frequency band in an undivided state.

Example M3 includes the method of Example M1 or M2, wherein a first spectral region has a first constellation goal and a second spectral region has a second constellation goal, and wherein a first determined CFR noise level for the first spectral region supports the first constellation goal and a second determined CFR noise level for the second spectral region supports the second constellation goal.

Example M4 includes the method of Example M1, M2 or M3, wherein the first constellation goal is 256-QAM, and wherein the second constellation goal is 1024-QAM.

Example M5 includes the method of any of Examples M1-M4, wherein a third spectral region has a third constellation goal and a third determined CFR noise level for the third spectral region supports the third constellation goal.

Example M6 includes the method of any of Examples M1-M5, wherein the third constellation goal is equal to one of the first constellation goal or the second constellation goal.

Example M7 includes the method of any of Examples M1-M6, wherein the cancellation pulse is based on a frequency mask using a fast Fourier transform (FFT) or a digital filter.

Example M8 includes the method of any of Examples M1-M7, wherein creating the cancellation pulse includes assigning the scaling factors for the cancellation pulse based on a target error vector magnitude (EVM) range for each spectral region, employing a mask on the cancellation pulse based on the scaling factors, determining, for each spectral region, if an average EVM falls within the target EVM range, lowering a respective scaling factor in the mask for each spectral region where the average EVM is higher than the target EVM range, and raising the respective scaling factor in the mask for each spectral region where the average EVM is lower than the target EVM range.

Example S1 includes a computing system comprising a processor, and a memory coupled to the processor, the memory comprising instructions which, when executed by the processor, cause the computing system to perform operations comprising dividing a frequency band into a plurality of spectral regions, assigning a constellation goal for each spectral region, wherein a respective constellation goal for at least two spectral regions is different, determining a crest factor reduction (CFR) noise level for each spectral region based on the constellation goal for each spectral region and a target CFR noise level for the divided frequency band, creating a cancellation pulse based on scaling factors, and based on the cancellation pulse, applying a cancellation pulse signal on a per-spectral region basis to generate transmission signals having the determined CFR noise level for each spectral region.

Example S2 includes the computing system of Example S1, wherein the target CFR noise level for the divided frequency band is approximately the same as an average CFR noise level for the frequency band in an undivided state.

Example S3 includes the computing system of Example S1 or S2, wherein a first spectral region has a first constellation goal and a second spectral region has a second constellation goal, and wherein a first determined CFR noise level for the first spectral region supports the first constellation goal and a second determined CFR noise level for the second spectral region supports the second constellation goal.

Example S4 includes the computing system of Example S1, S2 or S3, wherein the first constellation goal is 256-QAM, and wherein the second constellation goal is 1024-QAM.

Example S5 includes the computing system of any of Examples S1-S4, wherein a third spectral region has a third constellation goal and a third determined CFR noise level for the third spectral region supports the third constellation goal.

Example S6 includes the computing system of any of Examples S1-S5, wherein the third constellation goal is equal to one of the first constellation goal or the second constellation goal.

Example S7 includes the computing system of any of Examples S1-S6, wherein the cancellation pulse is based on a frequency mask using a fast Fourier transform (FFT) or a digital filter.

Example S8 includes the computing system of any of Examples S1-S7, wherein creating the cancellation pulse includes assigning the scaling factors for the cancellation pulse based on a target error vector magnitude (EVM) range for each spectral region, employing a mask on the cancellation pulse based on the scaling factors, determining, for each spectral region, if an average EVM falls within the target EVM range, lowering a respective scaling factor in the mask for each spectral region where the average EVM is higher than the target EVM range, and raising the respective scaling factor in the mask for each spectral region where the average EVM is lower than the target EVM range.

Example C1 includes at least one computer readable storage medium comprising a set of instructions which, when executed by a computing device, cause the computing device to perform operations comprising dividing a frequency band into a plurality of spectral regions, assigning a constellation goal for each spectral region, wherein a respective constellation goal for at least two spectral regions is different, determining a crest factor reduction (CFR) noise level for each spectral region based on the constellation goal for each spectral region and a target CFR noise level for the divided frequency band, creating a cancellation pulse based on scaling factors, and based on the cancellation pulse, applying a cancellation pulse signal on a per-spectral region basis to generate transmission signals having the determined CFR noise level for each spectral region.

Example C2 includes the at least one computer readable storage medium of Example C1, wherein the target CFR noise level for the divided frequency band is approximately the same as an average CFR noise level for the frequency band in an undivided state.

Example C3 includes the at least one computer readable storage medium of Example C1 or C2, wherein a first spectral region has a first constellation goal and a second spectral region has a second constellation goal, and wherein a first determined CFR noise level for the first spectral region supports the first constellation goal and a second determined CFR noise level for the second spectral region supports the second constellation goal.

Example C4 includes the at least one computer readable storage medium of Example C1, C2 or C3, wherein the first constellation goal is 256-QAM, and wherein the second constellation goal is 1024-QAM.

Example C5 includes the at least one computer readable storage medium of any of Examples C1-C4, wherein a third spectral region has a third constellation goal and a third determined CFR noise level for the third spectral region supports the third constellation goal.

Example C6 includes the at least one computer readable storage medium of any of Examples C1-C5, wherein the third constellation goal is equal to one of the first constellation goal or the second constellation goal.

Example C7 includes the at least one computer readable storage medium of any of Examples C1-C6, wherein the cancellation pulse is based on a frequency mask using a fast Fourier transform (FFT) or a digital filter.

Example C8 includes the at least one computer readable storage medium of any of Examples C1-C7, wherein creating the cancellation pulse includes assigning the scaling factors for the cancellation pulse based on a target error vector magnitude (EVM) range for each spectral region, employing a mask on the cancellation pulse based on the scaling factors, determining, for each spectral region, if an average EVM falls within the target EVM range, lowering a respective scaling factor in the mask for each spectral region where the average EVM is higher than the target EVM range, and raising the respective scaling factor in the mask for each spectral region where the average EVM is lower than the target EVM range.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the platform within which the example is to be implemented, i.e., such specifics should be well within purview of one skilled in the art. Where specific details (e.g., circuits) are set forth in order to describe example examples, it should be apparent to one skilled in the art that examples can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the examples can be implemented in a variety of forms. Therefore, while the examples have been described in connection with particular examples thereof, the true scope of the examples should not be so limited since other modifications will become apparent to the skilled practitioner upon a study of the drawings, specification, and following claims.

We claim:

1. A method comprising:
dividing a frequency band into a plurality of spectral regions;
assigning a constellation goal for each spectral region, wherein a respective constellation goal for at least two spectral regions is different;
determining a crest factor reduction (CFR) noise level for each spectral region based on the constellation goal for each spectral region and a target CFR noise level for the divided frequency band;
creating a cancellation pulse based on scaling factors; and
based on the cancellation pulse, applying a cancellation pulse signal on a per-spectral region basis to generate transmission signals having the determined CFR noise level for each spectral region.

2. The method of claim 1, wherein the target CFR noise level for the divided frequency band is approximately the same as an average CFR noise level for the frequency band in an undivided state.

3. The method of claim 1, wherein a first spectral region has a first constellation goal and a second spectral region has a second constellation goal, and wherein a first determined CFR noise level for the first spectral region supports the first constellation goal and a second determined CFR noise level for the second spectral region supports the second constellation goal.

4. The method of claim 3, wherein the first constellation goal is 256-QAM, and wherein the second constellation goal is 1024-QAM.

5. The method of claim 3, wherein a third spectral region has a third constellation goal and a third determined CFR noise level for the third spectral region supports the third constellation goal.

6. The method of claim 5, wherein the third constellation goal is equal to one of the first constellation goal or the second constellation goal.

7. The method of claim 1, wherein the cancellation pulse is based on a frequency mask using a fast Fourier transform (FFT) or a digital filter.

8. The method of claim 7, wherein creating the cancellation pulse includes:
assigning the scaling factors for the cancellation pulse based on a target error vector magnitude (EVM) range for each spectral region;
employing a mask on the cancellation pulse based on the scaling factors;
determining, for each spectral region, if an average EVM falls within the target EVM range;
lowering a respective scaling factor in the mask for each spectral region where the average EVM is higher than the target EVM range; and
raising the respective scaling factor in the mask for each spectral region where the average EVM is lower than the target EVM range.

9. A computing system comprising:
a processor, and
a memory coupled to the processor, the memory comprising instructions which, when executed by the processor, cause the computing system to perform operations comprising:
dividing a frequency band into a plurality of spectral regions;
assigning a constellation goal for each spectral region, wherein a respective constellation goal for at least two spectral regions is different;
determining a crest factor reduction (CFR) noise level for each spectral region based on the constellation goal for each spectral region and a target CFR noise level for the divided frequency band;
creating a cancellation pulse based on scaling factors; and
based on the cancellation pulse, applying a cancellation pulse signal on a per-spectral region basis to generate transmission signals having the determined CFR noise level for each spectral region.

10. The computing system of claim 9, wherein the target CFR noise level for the divided frequency band is approximately the same as an average CFR noise level for the frequency band in an undivided state.

11. The computing system of claim 9, wherein a first spectral region has a first constellation goal and a second spectral region has a second constellation goal, and wherein a first determined CFR noise level for the first spectral region supports the first constellation goal and a second determined CFR noise level for the second spectral region supports the second constellation goal.

12. The computing system of claim 11, wherein the first constellation goal is 256-QAM, and wherein the second constellation goal is 1024-QAM.

13. The computing system of claim 11, wherein a third spectral region has a third constellation goal and a third determined CFR noise level for the third spectral region supports the third constellation goal, and wherein the third constellation goal is equal to one of the first constellation goal or the second constellation goal.

14. The computing system of claim 9, wherein the cancellation pulse is based on a frequency mask using a fast Fourier transform (FFT) or a digital filter, and wherein creating the cancellation pulse includes:
assigning the scaling factors for the cancellation pulse based on a target error vector magnitude (EVM) range for each spectral region;
employing a mask on the cancellation pulse based on the scaling factors;
determining, for each spectral region, if an average EVM falls within the target EVM range;
lowering a respective scaling factor in the mask for each spectral region where the average EVM is higher than the target EVM range; and
raising the respective scaling factor in the mask for each spectral region where the average EVM is lower than the target EVM range.

15. At least one computer readable storage medium comprising a set of instructions which, when executed by a computing device, cause the computing device to perform operations comprising:
dividing a frequency band into a plurality of spectral regions;
assigning a constellation goal for each spectral region, wherein a respective constellation goal for at least two spectral regions is different;
determining a crest factor reduction (CFR) noise level for each spectral region based on the constellation goal for each spectral region and a target CFR noise level for the divided frequency band;
creating a cancellation pulse based on scaling factors; and
based on the cancellation pulse, applying a cancellation pulse signal on a per-spectral region basis to generate transmission signals having the determined CFR noise level for each spectral region.

16. The at least one computer readable storage medium of claim 15, wherein the target CFR noise level for the divided frequency band is approximately the same as an average CFR noise level for the frequency band in an undivided state.

17. The at least one computer readable storage medium of claim 15, wherein a first spectral region has a first constellation goal and a second spectral region has a second constellation goal, and wherein a first determined CFR noise level for the first spectral region supports the first constellation goal and a second determined CFR noise level for the second spectral region supports the second constellation goal.

18. The at least one computer readable storage medium of claim 17, wherein the first constellation goal is 256-QAM, and wherein the second constellation goal is 1024-QAM.

19. The at least one computer readable storage medium of claim 17, wherein a third spectral region has a third constellation goal and a third determined CFR noise level for the third spectral region supports the third constellation goal, and wherein the third constellation goal is equal to one of the first constellation goal or the second constellation goal.

20. The at least one computer readable storage medium of claim 15, wherein the cancellation pulse is based on a frequency mask using a fast Fourier transform (FFT) or a digital filter, and wherein creating the cancellation pulse includes:
assigning the scaling factors for the cancellation pulse based on a target error vector magnitude (EVM) range for each spectral region;
employing a mask on the cancellation pulse based on the scaling factors;
determining, for each spectral region, if an average EVM falls within the target EVM range;
lowering a respective scaling factor in the mask for each spectral region where the average EVM is higher than the target EVM range; and
raising the respective scaling factor in the mask for each spectral region where the average EVM is lower than the target EVM range.
